(19) United States
(12) Patent Application Publication
(10) Pub. No.: US 2010/0231364 A1
(43) Pub. Date: Sep. 16, 2010

(54) REMINDER NOTIFICATION FOR ELECTRONIC DEVICES

(75) Inventors: Hans Markus Laine, Oulu (FI); Jarno Tapio Vayrynen, Oulu (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/404,640

(22) Filed: Mar. 16, 2009

(51) Int. Cl. G08B 1/00; H04W 4/14; H04M 1/00

(52) U.S. Cl. 340/309.7; 455/466; 455/550.1

(57) ABSTRACT

Methods, devices, and computer program products are provided to allow the generation, transmission and the reception of reminder notices in a very simple fashion. An independent reminder handling application allows a user to simply enter information including the names of one or more recipients, a trigger time, and a main body of the reminder notice. Upon transmission of the reminder notice to one or more recipients, a representation of the reminder is exhibited at the recipient devices. The reminder handling application drastically facilitates the generation and reception of reminder notices since the user and the recipients are not required to navigate through several screens, browse through one or more lists of available options, or access other applications.

### FIELD OF INVENTION

This invention relates to electronic devices capable of sending and receiving electronic messages. In particular, the present invention relates to methods and devices for facilitating sending reminder messages to and from such devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Sending and receiving electronic messages have become a routine part of present day communications. As the capabilities of electronic devices and the sophistication of messaging capabilities increase, sending and receiving such messages have also become more complicated. For example, in order to send a message such as a reminder notice, a user is often required to navigate through several screens, browse through one or more lists of available options, open several applications that provide assistance with the preparation and customization of the message, and decide among various delivery options before transmitting a message.

These potentially complicated steps are likely to confuse unsophisticated users of the device or messaging service, and may discourage or preclude them from using the electronic device and its services all together. More specifically, the complexity of sending or even acknowledging the receipt of present-day electronic reminder alarms may prevent a large number of senior citizens from using such reminder capabilities to, for example, keep track of their daily medication needs, and to provide timely reminders regarding the number and the type of medications.

### SUMMARY OF THE INVENTION

It is therefore advantageous to provide a methods, apparatus, and computer program products that allow the generation, transmission and the reception of reminder notices in a very simple fashion.

One aspect of the present invention relates to a method comprising launching a reminder handling application, the reminder handling application being independent of other applications on an electronic device; receiving information related to a reminder notice from the user, the information being related to identification of one or more intended recipients of the reminder notice, a trigger time associated with the reminder notice, and a description of the reminder notice contents; generating a reminder notice; and transmitting the reminder notice, wherein upon receipt of the reminder notice by one or more recipient devices in compliance with a pre-existing agreement, a representation of the reminder notice is exhibited at the one or more recipient devices in accordance with the trigger time.

In one embodiment, the representation of the reminder notice comprises at least one of an audio, visual or vibration alarm. In one embodiment, the reminder notice is communicated using short messaging service (SMS). In one embodiment, the reminder handling application is installed on an electronic device and on the one or more recipient devices, and transmission of the pre-existing agreement allows the transmitting of the reminder notice and allows acceptance of the reminder notice by the one or more recipient devices.

In one embodiment, upon exhibition of the representation of the reminder notice, the one or more recipient devices acknowledge the receipt of the reminder notice. In one embodiment, the reminder handling application is incorporated into an Internet website service, and in another embodiment, the reminder notice further comprises at least one of an audio, image or multimedia content.

Another aspect of the present invention relates to a computer program product, embodied on a computer-readable medium, comprising computer code for launching a reminder handling application, the reminder handling application being independent of other applications on an electronic device, computer code for receiving information related to a reminder notice from the user, the information being related to identification of one or more recipients of the reminder notice, a trigger time associated with the reminder notice, and a description of the reminder notice contents, computer code for generating a reminder notice, and computer code for transmitting the reminder notice, wherein upon receipt of the reminder notice by one or more recipient devices in compliance with a pre-existing agreement, a representation of the reminder notice is exhibited at the one or more recipient devices in accordance with the trigger time.

Another aspect of the present invention relates to an apparatus comprising a processor, and a memory unit operatively connected to the processor and including computer code for launching a reminder handling application, the reminder handling application being independent of other applications on an electronic device, computer code for receiving information related to a reminder notice from the user, the information being related to identification of one or more recipients of the reminder notice, a trigger time associated with the reminder notice, and a description of the reminder notice contents, computer code for generating a reminder notice, and computer code for transmitting the reminder notice, wherein upon receipt of the reminder notice by one or more recipient devices in compliance with a pre-existing agreement, a representation of the reminder notice is exhibited at the one or more recipient devices in accordance with the trigger time.

Another aspect of the present invention relates to a method comprising receiving a reminder notice from one or more devices connected to a communication network in compliance with a pre-existing agreement, determining a trigger time associated with the reminder notice, and launching a reminder handling application in accordance with the trigger time, wherein the reminder handling application is independent of other applications on a recipient device, and the reminder handling application exhibits a representation of the reminder notice on the recipient device.

In another aspect, the present invention relates to a computer program product, embodied on a computer-readable medium, comprising computer receiving a reminder notice from one or more devices connected to a communication network in compliance with a pre-existing agreement, computer code for determining a trigger time associated with the reminder notice, and computer code for launching a reminder handling application in accordance with the trigger time, wherein the reminder handling application is independent of other applications on a recipient device, and the reminder handling application exhibits a representation of the reminder notice on the recipient device.

Another aspect of the present invention relates to an apparatus comprising a processor, and a memory unit operatively connected to the processor and including computer code for receiving a reminder notice from one or more devices connected to a communication network in compliance with a pre-existing agreement, computer code for determining a trigger time associated with the reminder notice, and computer code for launching a reminder handling application in accordance with the trigger time, wherein the reminder handling application is independent of other applications on a recipient device, and the reminder handling application exhibits a representation of the reminder notice on the recipient device.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates a perspective view of an exemplary electronic device within which various embodiments of the present invention may be implemented;

FIG. 2 illustrates an exemplary schematic representation of the circuitry which may be included in the electronic device of FIG. 1;

FIG. 3 is a flow chart illustrating the generation of a reminder notice in accordance with an embodiment of the present invention;

FIG. 4 illustrates an example user interface in accordance with an embodiment of the present invention;

FIG. 5 illustrates an example user interface in accordance with an embodiment of the present invention;

FIG. 6 is a flow chart illustrating the reception of a reminder notice in accordance with an embodiment of the present invention; and

FIG. 7 is an overview diagram of a system within which various embodiments of the present invention may be implemented.

### DETAILED DESCRIPTION OF CERTAIN EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

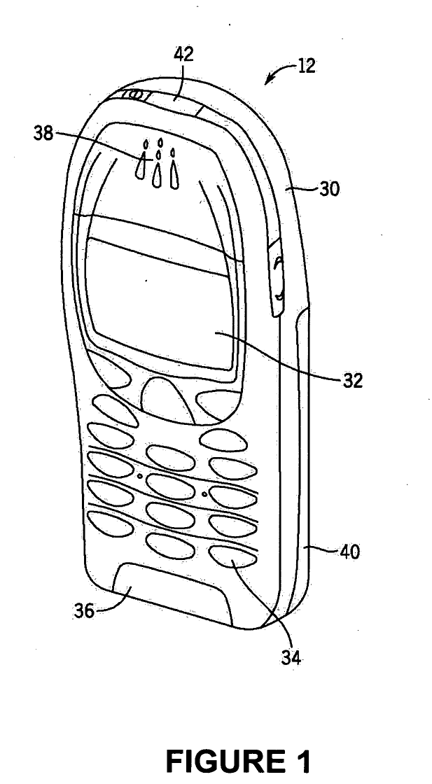

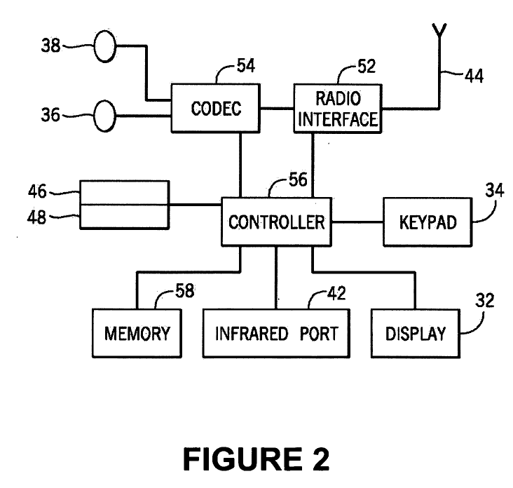

FIGS. 1 and 2 show one representative electronic device 12 which may be used as either the sending entity or a receiving entity of the messages that are produced in accordance with the various embodiments of the present invention. It should be understood, however, that the present invention is not intended to be limited to one particular type of device. The electronic device 12 of FIGS. 1 and 2 includes a housing 30, a display 32, for example, in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The electronic device 12 may comprise fewer or additional components. These additional components may include, but are not limited to, a touch sensitive screen that allows text entry and/or other user interactions with the electronic device. The above described components enable the electronic device 12 to send/receive various messages to/from other devices in accordance with the various embodiments of the present invention. Individual circuits and elements are all of a type well known in the art, for example in the Nokia range of mobile telephones.

The methods, devices and computer program products in accordance with embodiments of the present invention simplify the generation, transmission and reception of reminder messages to one or more remote electronic devices. The various embodiments of the present invention also enable triggering remote alarms on one or more mobile devices from an electronic device, such as a mobile device. According to one embodiment of the present invention, reminder handling capabilities may be integrated into web services of, for example, a social networking or contact management websites. These and other features of the present invention enable an unsophisticated user of an electronic device to prepare, transmit and receive electronic reminder messages without using a calendar or clock application, thus allowing the user to send and/or receive important reminder messages with little or no knowledge of electronic gadgetry or other software applications.

These and other features may be enabled by providing a separate and independent reminder handling application that is dedicated to handling and triggering remote alarms on electronic devices. The reminder handling application must be installed on both the sending and the receiving devices. The sender of the reminder alarm may simply enter information related to the recipient(s), time and date of the reminder trigger, and other informative items without opening additional applications such as an electronic calendar. The reminder information may then be transmitted to one or more recipient devices and viewed by the recipients at the designated time. The reminder may further trigger an alarm that visually and/or aurally notifies the recipients. The reminder notification may be viewable at the recipient device at the exact time specified by the sender. Alternatively, or additionally, the reminder notice may be viewable at one or more predetermined times before and/or after the trigger time specified by the sender.

The following description provides an example scenario in which a reminder alarm generation capability may be utilized. In the example, Matti and Sirkka are a married couple. Matti would like to send a reminder directly to Sirkka's mobile device so that an alarm functionality, with an appropriate message, is triggered on Sirkka's device. In addition, Matti would like to be able to specify an exact moment for the alarm to be triggered. On one hand, Matti may be able to accomplish these goals by remembering to call Sirkka or send a Short Messaging Service (SMS) message at the desired time, or even leave a handwritten note for Sirkka. On the other hand, Matti may be able to navigate through electronic calendaring system, which includes multiple steps and decision screens, to schedule an electronic alarm notification for Sirkka. However, these steps may be bypassed by utilizing the simple reminder handling application of the present invention. The reminder handling application that is, for example, pre-installed on Matti mobile device allows Matti to send timed or instant reminders to one or more recipient devices.

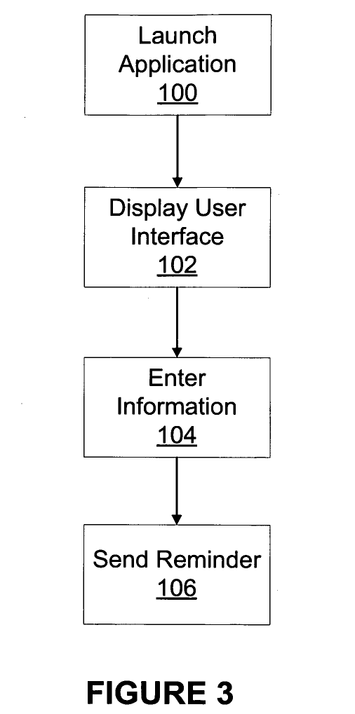

FIG. 3 is a flow chart illustrating the generation of a reminder notice in accordance with an embodiment of the present invention. The sequence of operations that are shown in FIG. 3 illustrate the exemplary steps for generating and sending remote reminder notices from user A to one or more recipients in accordance with an embodiment of the present invention. Prior to initiation of the reminder message, the two parties must have reached a mutual agreement to allow receiving/sending reminder to one another. This task may be accomplished, for example, by placing the party's name, email or other identification information on a trusted list of senders and/or recipients. For example, a list of allowed contacts may be created as part of a phonebook, or may reside on an Internet-based service that allows sending and/or receiving of reminder messages. Having reached a mutual agreement, one or both parties are then allowed to transmit messages to the other parties either immediately or at a given time. Furthermore, the receiving party does not have to agree to, or process separately, each received reminder message. For example, user A is enabled to force reminder messages to his/her grandmother, with instructions to take certain medications at specific times. Reaching a mutual agreement prior to sending/receiving messages also facilitates the privacy of communications between the two parties, and prevents unwanted and/or unsolicited reminder messages from reaching the recipient. Referring back to FIG. 3, at block 100, user A initiates the process by launching the reminder handling application that resides on an electronic device. The application may, for example, be initiated by clicking on, or touching, an icon that is displayed on the screen of the electronic device. The electronic device may further be equipped with a microphone and voice recognition software and/or hardware circuitry, thus allowing user A to additionally, or alternatively, launch the application through voice commands. At block 102, a simple user interface (UI) is displayed on the device. At block 104, user A provides the reminder handling application with various information that is necessary for the generation of the reminder notice. This information may include the identity of the recipient(s), such as their names, phone numbers, and/or email addresses, the main body (i.e., contents) of the reminder message, and the activation or trigger time associated with the reminder notice. At block 106, the reminder notice is transmitted to one or more recipients upon user A's completion of the information entry in block 104. User A may initiate the transmission of the reminder information in block 106 by, for example, pressing a ‘send’ button.

It should be noted that, at blocks 104 and 106, user A is not required to access other applications or programs, such as calendaring applications. In fact, the user may simply enter the required information and allow the reminder handling application to carry out all other necessary steps. For example, user A may type, handwrite, or use voice commands to enter the required information. In one example embodiment, the user device may be equipped with a speaker and a microphone, which allow some or all operations at blocks 100 to 106 to take place through voice interactions between the device and user A. For example, user A may launch the application through a voice command, and the application may then ask user A to respond to a series of questions to collect the necessary information. In another example embodiment, user A may handwrite the required information by, for example, using a stylus equipped with a handwriting recognition software and/or hardware that are operatively connected to the electronic device. In this example embodiment, the handwriting recognition software/hardware recognizes user A's handwritten entry and automatically fills in the required fields in the reminder handling UI. The use of voice and/or handwritten commands is particularly advantageous for users that are not technologically savvy, or the ones with physical handicaps.

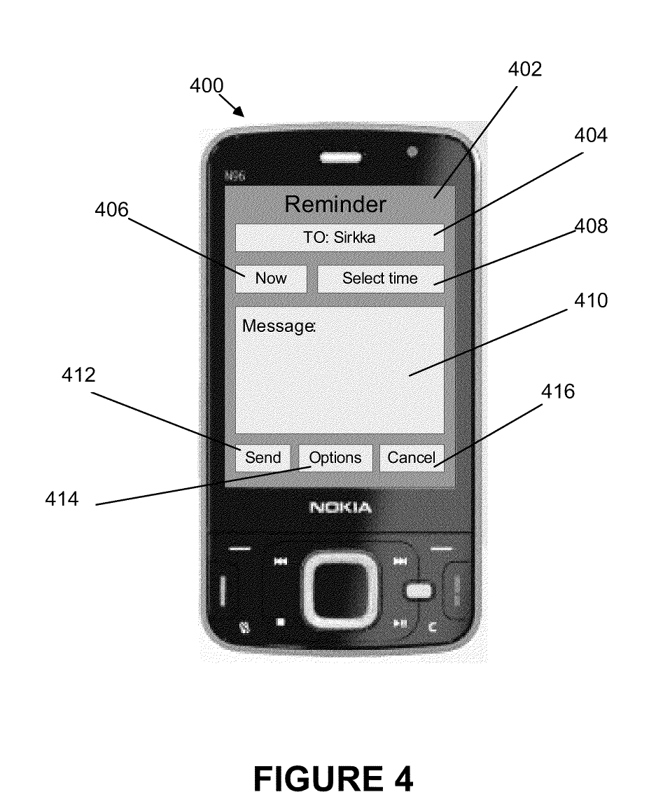

FIG. 4 illustrates an example UI 402 in accordance with an embodiment of the present invention. The UI 402 may appear on a electronic device 400 after the launch of the reminder handling application. The exemplary UI 402 presents the user with a few basic options for generating a reminder notice. For example, the ‘TO’ 404 field allows the user to designate the name of one or more recipients of the reminder notice. The ‘Now’ 406 field allows the user to send an instant reminder to the recipient, while the ‘Select Time’ 408 field allows the user to enter a specific time and date for the triggering of the reminder notice on the recipient's device. The ‘Message’ 410 field is designed to allow the user to enter the desired message content. The ‘Cancel’ 416 field allows the user to cancel the reminder generation process, and may further close the reminder handling application. The field labeled as ‘options’ 414 provides additional features that may be available to the user. These options may include, but are not limited to, attaching one or more files to the reminder message, specifying recurrence frequency of the reminder message, providing different notification options that are triggered on the recipient's device, and the like. It should be noted that an unsophisticated user of the device may only enter the most basic information, such as the name of the recipient, the trigger time, and the body of the message, while foregoing the more advanced features that are available though the ‘Options’ 414 field. The ‘Send’ 412 field allows the user to send the reminder notice to one or more recipients. The exemplary UI of FIG. 4(a) shows a specific combination of data entry (such as the Message 410) and soft key (such as the Send 412) fields. However, it is understood that a different combination of data entry and soft key fields may be used to implement the various feature of reminder handling application. In addition, the UI of the reminder handling application may comprise additional or fewer fields.

Referring again to the above example related to Matti and Sirkka, Matti may populate the various fields of the reminder handling application UI and send the reminder message to Sirkka. For example, Matti may select Sirkka as the recipient, select a particular time for the remote alarm to be triggered, type the desired message (e.g., a list of items to be bought from a supermarket, etc.), and send the reminder to the Sirkka.

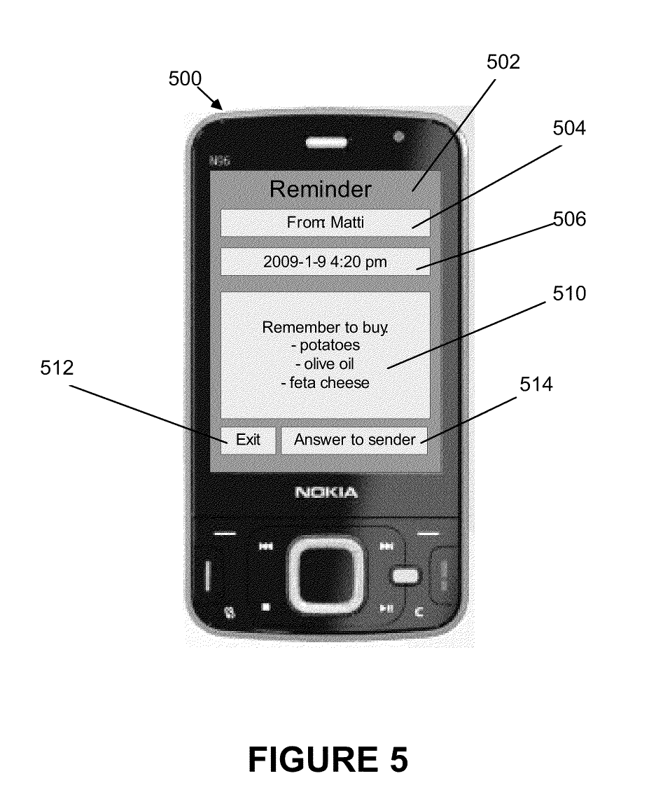

FIG. 5 illustrates an example reminder representation UI 502 that may be exhibited on Sirkka's device 500 at the time specified by Matti. In the example depicted in FIG. 5, the ‘From’ 504 field identifies Matti as the sender of the reminder, the trigger date and time 506 is specified as ‘2009-1-9 4:20 pm’ (i.e., Jan. 1, 2009), and the main body 510 of the message includes a reminder to buy certain grocery items. The recipient of the message (e.g., Sirkka) may exit the reminder application UI by pressing the ‘Exit’ 512 field, or to ‘Answer to sender’ 514 by activating the corresponding field on the UI. The activation of the Exit 512 and/or the Answer to Sender 514 fields may also generate an automatic acknowledgment message that is relayed back to the sender. It should be noted the UI 502 on the recipient device 500 may comprise fewer or additional fields to simplify and/or to enhance the capabilities of the application as desired. The exhibition of the reminder UI 502 at the recipient device 500 may further be accompanied by an alarm that produces, for example audio and/or visual notification announcements and/or produces vibrations.

The simple reminder handling application of the present invention can be used to send a reminder alarm to an elderly relative as a one-time, or recurring, reminder to take his/her medications. In such a scenario, the application UI of the present invention provides the necessary functionalities with minimum complexity. For example, the reminder notice UI may be accompanied by a noticeable alarm, such as loud beeps or flashing lights. In addition, the recipient may simply acknowledge the reminder by issuing an acknowledgement command (e.g., press a key, respond with a voice command, and the like). In another example scenario, a user may send a simple reminder notice to a plurality of recipients a few days before a scheduled event using the reminder handling application of the present invention. The sender may compose and transmit the reminder notice at his/her time of choosing. Upon the reception of the reminder notice, the recipient devices may only exhibit the reminder UI and the associated alarm at a specific trigger time (e.g., one hour before the scheduled event).

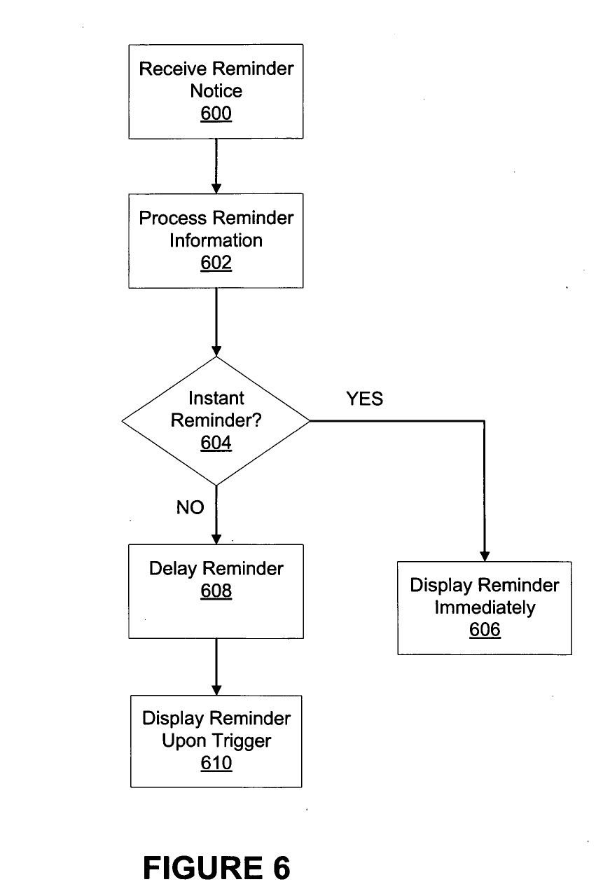

FIG. 6 is a flow chart illustrating the exemplary operations that may be carried out at a recipient device in response to the reception of a reminder notice from one or more sender devices. At block 600, the device receives the reminder notification from one or more remote devices. At block 602, the device processes all, or certain portions, of the received reminder notice, which may include identification of the message type and/or senders of the information. At block 604, the message is examined to determine if the reminder information must be exhibited immediately. If the answer is yes, at block 606, the reminder information is appropriately exhibited at the recipient device. This exhibition may include, for example, the display of reminder handling application UI that was depicted in FIG. 5, in addition to one or more notification alarms. If the received reminder notice does not require immediate notification, at block 608, the exhibition of the reminder notice is delayed until the specified trigger time. Finally, at block 610, the recipient device exhibits the reminder information, and possibly audio/visual/vibration alarms, at the specified trigger time.

To allow seamless communication of reminder notices between the sender and recipient devices, the reminder handling application of the present invention must be installed in both devices. The two devices must also make a mutual agreement to allow sending and receiving reminders to/from each other. The communication of reminder notices may be accomplished through SMS extensions, for example, by using the current Multimedia Messaging Service (MMS) extension. MMS is an extension of the SMS standard, allowing longer message lengths and using Wireless Application Protocol (WAP) to display the content. Alternatively, a new SMS extension may be used (e.g., a Reminder or REM message). The information regarding the reminder notice may be included in the header portion of the message. SMS parsing such as header, type, time, from and message may be included and sent to the recipients inside a REM message. The differentiating factor is the format or “type” of messages. In another variation, the reminder messages may be communicated by sending a specific Bluetooth message to one or more recipient devices. The communication of reminder notices may also be accomplished through an independent Reminder server. This alternate embodiment requires an independent server, and the use of data transferring services from the mobile device. The use of an independent sever allows the communication of much more sophisticated reminder notices that, for example, include sounds, pictures and videos. The reminder notification may also be retrieved using Near Field Communication (NFC) tags. NFC is a short-range wireless connectivity technology that offers simple, intuitive, and safe communication between electronic devices. The reminder messages may be communicated using NFC, for example, according to one or more of the following: (1) the reminder messages may be created and stored into an NFC tag; (2) the reminder messages may be received or picked by touching an NFC tag; and (3) the reminder message may be created in a first device and “given” or transferred to one or more devices when the first device “touches” the one or more other devices.

In accordance with another embodiment of the present invention, reminder handling application may be integrated into social networking or contact management web services, such as Ovi.com. Under this implementation, the users of the web services may send and receive reminder notices to/from other mobile devices and/or other users of the web services. Such an implementation further proliferates the usage of reminder notices that may include sounds, images and multimedia content. Furthermore, preexisting user and friend groups associated with such network services may be utilized to more easily generate and transmit reminder notices to targeted groups.

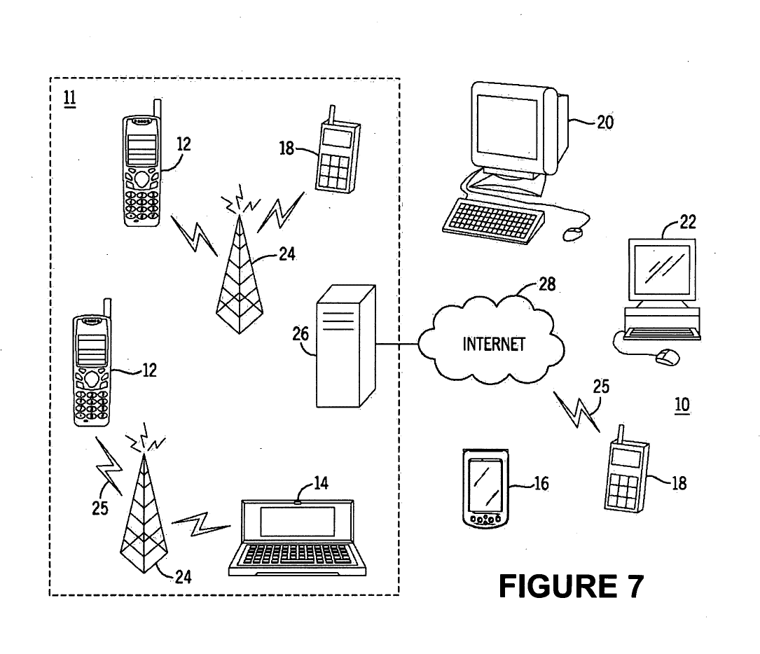

For exemplification, FIG. 7 shows a system 10 within which various embodiments of the present invention may be implemented. The system 10 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like. The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. A computer-readable medium may include removable and non-removable storage devices including, but not limited to, Read Only Memory (ROM), Random Access Memory (RAM), compact discs (CDs), digital versatile discs (DVD), etc. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
launching a reminder handling application, the reminder handling application being independent of other applications on an electronic device;
receiving information related to a reminder notice, the information being related to identification of one or more intended recipients of the reminder notice, a trigger time associated with the reminder notice, and a description of the reminder notice contents;
generating a reminder notice; and
transmitting the reminder notice,
wherein upon receipt of the reminder notice by one or more recipient devices in compliance with a pre-existing agreement, a representation of the reminder notice is exhibited at the one or more recipient devices in accordance with the trigger time.

2. The method of claim 1, wherein the representation of the reminder notice comprises at least one of an audio, visual or vibration alarm.

3. The method of claim 1, wherein the reminder notice is communicated using short messaging service (SMS).

4. The method of claim 1,
wherein the reminder handling application is installed on an electronic device and on the one or more recipient devices; and
wherein the pre-existing agreement allows the transmitting of the reminder notice and allows acceptance of the reminder notice by the one or more recipient devices.

5. The method of claim 1, wherein upon exhibition of the representation of the reminder notice, the one or more recipient devices acknowledge the receipt of the reminder notice.

6. The method of claim 1, wherein the reminder handling application is incorporated into an Internet website service.

7. The method of claim 1, wherein the reminder notice further comprises at least one of an audio, image or multimedia content.

8. A computer program product, embodied on a computer-readable medium, comprising:
computer code for launching a reminder handling application, the reminder handling application being independent of other applications on an electronic device;
computer code for receiving information related to a reminder notice, the information being related to identification of one or more intended recipients of the reminder notice, a trigger time associated with the reminder notice, and a description of the reminder notice contents;
computer code for generating a reminder notice; and
computer code for transmitting the reminder notice,
wherein upon receipt of the reminder notice by one or more recipient devices in compliance with a pre-existing agreement, a representation of the reminder notice is exhibited at the one or more recipient devices in accordance with the trigger time.

9. The computer program product of claim 8, wherein the representation of the reminder notice comprises at least one of an audio, visual or vibration alarm.

10. The computer program product of claim 8, further comprising computer code for enabling communication of the reminder notice using short messaging service (SMS).

11. The computer program product of claim 8, further comprising computer code for allowing the one or more recipient devices to acknowledge receipt of the reminder notice.

12. The computer program product of claim 8, wherein the reminder handling application is incorporated into an Internet website service.

13. The computer program product of claim 8, wherein the reminder notice further comprises at least one of an audio, image or multimedia content.

14. An apparatus, comprising:
a processor; and
a memory unit operatively connected to the processor and including:
computer code for launching a reminder handling application, the reminder handling application being independent of other applications on an electronic device;
computer code for receiving information related to a reminder notice, the information being related to identification of one or more intended recipients of the reminder notice, a trigger time associated with the reminder notice, and a description of the reminder notice contents;
computer code for generating a reminder notice; and
computer code for transmitting the reminder notice,
wherein upon receipt of the reminder notice by one or more recipient devices in compliance with a pre-existing agreement, a representation of the reminder notice is exhibited at the one or more recipient devices in accordance with the trigger time.

15. The apparatus of claim 14, wherein the representation of the reminder notice comprises at least one of an audio, visual or vibration alarm.

16. The apparatus of claim 14, further comprising computer code for enabling communication of the reminder notice using short messaging service (SMS).

17. The apparatus of claim 14, further comprising computer code for allowing the one or more recipient devices to acknowledge receipt of the reminder notice.

18. The apparatus of claim 14, wherein the reminder handling application is incorporated into an Internet website service.

19. The apparatus of claim 14, wherein the reminder notice further comprises at least one of an audio, image or multimedia content.

20. A method, comprising:
receiving a reminder notice from one or more devices connected to a communication network in compliance with a pre-existing agreement;
determining a trigger time associated with the reminder notice; and
launching a reminder handling application in accordance with the trigger time,
wherein the reminder handling application is independent of other applications on a recipient device; and
wherein the reminder handling application exhibits a representation of the reminder notice.

21. A computer program product, embodied on a computer-readable medium, comprising:
computer code for receiving a reminder notice from one or more devices connected to a communication network in compliance with a pre-existing agreement;
computer code for determining a trigger time associated with the reminder notice; and
computer code for launching a reminder handling application in accordance with the trigger time,
wherein the reminder handling application is independent of other applications on a recipient device; and
wherein the reminder handling application exhibits a representation of the reminder notice on the recipient device.

22. An apparatus, comprising:
a processor; and
a memory unit operatively connected to the processor and including:
computer code for receiving a reminder notice from one or more devices connected to a communication network in compliance with a pre-existing agreement;
computer code for determining a trigger time associated with the reminder notice; and
computer code for launching a reminder handling application in accordance with the trigger time,
wherein the reminder handling application is independent of other applications on a recipient device; and
wherein the reminder handling application exhibits a representation of the reminder notice on the recipient device.
